(19) United States
(12) Patent Application Publication
(10) Pub. No.: US 2022/0249958 A1
(43) Pub. Date: Aug. 11, 2022

(54) CROSS-PLATFORM POINT EXCHANGE SYSTEM AND METHOD

(71) Applicant: OnlineCaiGuo Co.,Ltd., New Taipei City (TW)

(72) Inventor: WEN-HUA SHEN, New Taipei City (TW)

(21) Appl. No.: 17/582,779

(22) Filed: Jan. 24, 2022

(30) Foreign Application Priority Data
Feb. 5, 2021 (TW) 110104539

(51) Int. Cl. A63F 13/792

(52) U.S. Cl. CPC A63F 13/792

(57) ABSTRACT

A cross-platform point exchange system and a method thereof are disclosed herein. The system comprises an E-business platform, a point exchange platform and a game platform. The point exchange platform receiving member data of a member from the E-business platform, generating a webpage having a game list according to the games provides by the game platform, and receiving game selection information input by the member. The point exchange platform converts the feedback points in the member data into game points of a loyalty card and provides the game points to a selected game corresponding to the game selection information. Via the connection of the E-business platform, the point exchange platform and the game platform, the present invention can convert the feedback points of the E-business platform into game points, to expand the application field of bonus points and accelerate the digestion of bonus points.

This application claims priority of Application No. 110104539 filed in Taiwan on 5 Feb. 2021 under 35 U.S.C. § 119; the entire contents of all of which are hereby incorporated by reference.

### BACKGROUND OF THE INVENTION

### Field of the Invention

The present invention relates to a loyalty card exchange method, particularly to a cross-platform point exchange system and a method thereof.

### Description of the Prior Art

Shopping websites, electronic commerce platforms, etc. will feed back bonus points to consumers after their consumptions. However, bonus points are normally exchanged in a one-for-one way at present. Different bonus issuers need to negotiate the quid pro quo relationship therebetween. For example, the exchange ratio of Bonus A and Bonus B is 1:1 or 1:2. So far, there have been services for exchanging bonus points into channel points, food service points, E-business points, and these converted points may be may be used to offset a portion of consumption payment. However, the bonus points are likely to be digested slowly in the abovementioned cases. Besides, the bonus issuers have to pay for performance guarantee. If bonus points are expended slowly, the cost of performance guarantee will accumulate to a great amount, which a problem many bonus issuers encounter at present. If bonus points can be exchanged more extensively, the value of bonus points should be promoted.

At present, there is no mechanism to convert bonus points into game points. E-gaming is a popular industry nowadays. In most games, gamers have to use loyalty cards to purchase required equipment. Thus, many issuers of loyalty cards emerge. The platforms of loyalty card issuers are linked with the platforms of game providers. After the user buys a loyalty card with money (such as New Taiwan dollar), he may convert the loyalty card into game points of a specified game. If bonus points can be exchanged into game points, the application of bonus points will be diversified furthermore.

Hundreds of games are published in Taiwan, and the product life cycles thereof are different. Most of the bonus issuers are unlikely to link the platforms thereof to platforms of all the games one by one because much money would be spent in technical manpower and maintenance for one-by-one connections. Besides, the exchange rates of game coins are different. For example, the exchange rate of NTD to the game coin of Game A is 1:100, i.e. one NTD may be exchanged into 100 game coins of Game A. The exchange rate of NTD to the game coin of Game B may be 10:1, 1:30, 1:10000, etc. If a bonus issuer intends to link the platform thereof to the host computers of all game providers one by one, it has to establish a central liquidation system, which should burden the issuer a considerable amount of capital.

Accordingly, the present invention proposes a cross-platform point exchange system and a method thereof to overcome the conventional problems. The principle and embodiments of the present invention will be described in detail below.

### SUMMARY OF THE INVENTION

The primary objective of the present invention is to provide a cross-platform point exchange system and a method thereof, which convert the bonus points fed back by an E-business platform into game points, whereby bonus points can be digested faster, wherefore the cost of performance guarantee for bonus points of the E-business platform can be decreased.

Another objective of the present invention is to provide a cross-platform point exchange system and a method thereof, which increase the flexibility in the exchange line of the feedback points, wherefore the user needn't accumulate the points to a certain limit before he wants to use the points, and wherefore the application range of a minor amount of points is increased.

A further objective of the present invention is to provide a cross-platform point exchange system and a method thereof, wherein an application interface is used to link E-business platforms, point exchange platforms and game platforms, and wherein the application interface can automatically jump to a game platform for identifying the balance of game points, can automatically jump to an E-business platform for identifying the balance of feedback points, and wherein after the points are deducted, the application interface can automatically inform the game platform, and wherein the application interface can instantly enter into the game account of a member, whereby to save the time of manually inputting the serial number and password of a loyalty card and decrease the error rate of inputting the password, wherefore the present invention favors the game industry.

In order to achieve the abovementioned objectives, the present invention proposes a cross-platform point exchange system, which comprises an E-business platform storing a plurality of feedback points and at least one piece of member data of at least one member, wherein the member data has the feedback points; a game platform providing a plurality of games; and a point exchange platform in signal connection with the E-business platform and the game platform, receiving the member data, generating a webpage having a game list according to the games of the game platform, and receiving information about the game selected by the member, wherein the point exchange platform converts the feedback points in the member data into game points of a loyalty card and provides the game points to the selected game corresponding to the information of games selection.

In one embodiment, the member data includes a telephone number of the member, a mobile phone number of the member, an electronic mailbox of the member, or an account number registered in the E-business platform by the member, whereby the point exchange platform can verify whether the member binds himself to a game account number of a selected game in the game platform.

In one embodiment, after receiving the information of game selection, the point exchange platform jumps to the game platform for presenting an input webpage of the game account number.

In one embodiment, after the input webpage presented by the game platform receives the game account number, the game account number and the balance of the loyalty card are returned to the point exchange platform, and the point exchange platform presents the balance of the loyalty card of the game account number.

In one embodiment, the point exchange platform receives an exchange instruction input by a member; the exchange instruction includes an E-business platform, which is selected to exchange feedback points, and an exchange line. According to the exchange instruction, the point exchange platform links to the corresponding E-business platform to verify whether the feedback points are more than or equal to the exchange line.

In one embodiment, the loyalty cards include a plurality of game point cards provided by a plurality of point issuers. The point exchange platform provides the plurality of game point cards for the member to select at least one of the plurality of game point cards for feedback point exchange. The point exchange platform calculates the quid pro quo relationship to determine the exchange rate.

In one embodiment, while the feedback points are more than or equal to the exchange line, the E-business platform pre-deducts the points of the exchange line from the feedback points of the member. After the feedback points of the exchange line have been converted into game points of the loyalty card, the E-business platform confirms that the feedback points of the member have been deducted successfully.

In one embodiment, after the feedback points of the exchange line have been converted into the game points of the loyalty card, the point exchange platform deducts the points of the exchange line from the game points of the loyalty card and transmits the information of points to the game platform, whereby to inform the member of the game platform that the game points, which meets the exchange line, have been added to one game account of the member.

In one embodiment, a game server is connected to the rear end of the game platform for storing and executing games and also storing a plurality of game accounts and related information.

In one embodiment, an E-business server is connected to the rear end of the E-business platform for storing data, consumption records, and balances of the feedback points of the members in the E-business platform.

In one embodiment, the E-business server and the point exchange server respectively belong to different companies.

The present invention further proposes a cross-platform point exchange method, which converts a plurality of feedback points of an E-business platform into the game points required by a game platform via a point exchange platform, and which comprises steps: after the E-business platform receives login information of a member, the E-business platform links to a point exchange platform and provides member data to the point exchange platform, wherein the member data includes a plurality of feedback points; the game platform includes a plurality of games; the point exchange platform generates a webpage having a game list for selection according to the plurality of games, wherein the member selects a game from the game list as a selected game; after the point exchange platform receives a piece of game selection information input by the member and a game account number corresponding to the selected game, the point exchange platform verifies whether the member binds himself to the game account number of the selected game according to the member data; the point exchange platform receives an exchange line input by the member and links to the E-business platform to verify whether the feedback points of the member are more than or equal to the exchange line; and after the point exchange platform exchanges the feedback points of the exchange line for the game points of a game card, the point exchange platform deducts the exchange line from the game points of a loyalty card and transmits information of points to the game platform so as to inform the member of the game platform that the game points, which meets the exchange line, have been added to the game account number of the member.

### BRIEF DESCRIPTION OF THE DRAWINGS

FIG. 1 is a diagram schematically showing a cross-platform point exchange system 10 of the present invention.

FIG. 2 is a flowchart of a cross-platform point exchange method of the present invention.

FIG. 3 is a detailed flowchart of a cross-platform point exchange method of the present invention.

### DETAILED DESCRIPTION OF THE INVENTION

The present invention proposes a cross-platform point exchange system, wherein E-business platforms, point exchange platforms and game platforms are linked to each other, and wherein the user selects the game he desires to play, the feedback points he desires to exchange and the game points he desires to exchange through the point exchange platform, whereby the bonus points provided by the E-business platform may be converted into the game points in a cross-platform method and the game points may be provided to the game platform.

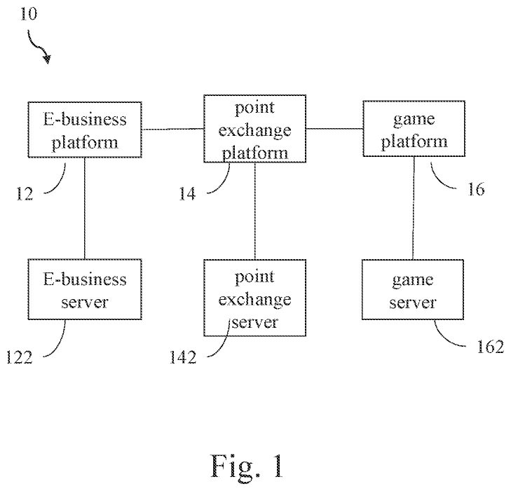

Refer to FIG. 1, which schematically shows a cross-platform point exchange system 10 of the present invention. The cross-platform point exchange system 10 comprises an E-business platform 12, a point exchange platform 14 and a game platform 16. The E-business platform 12 links to the point exchange platform 14. The point exchange platform 14 further links to the game platform 16. The E-business platform 12 includes various E-commerce industries and various platform businesses, which provide feedback points, such as shopping platforms. After the member has made consumption in the E-business platform 12, the E-business platform 12 will give the member feedback points according to the amount of consumption. The rear end of the E-business platform 12 is connected with an E-business server 122. In addition to the information of goods, the E-business server 122 stores member data, consumption records, balances of feedback points, etc. The member data includes personal information of members, such as telephone numbers, mobile phone numbers, electronic mailboxes, ID numbers, and account numbers registered in the E-business platform 12.

The game platform 16 provides a plurality of games. The rear end of the game platform 16 is connected with a game server 162. The game server 162 stores and executes games and also stores the game account numbers of a plurality of gamers and related information thereof, such as levels, equipment, coins, and intervals of playing games. The cross-platform point exchange system 10 may have a plurality of game platforms 16, and the game platforms 16 may respectively belong to different companies. However, these game platforms 16 all link to the same point exchange platform 14. For example, the game platform of Game Company A, the game platform of Game Company B, and the game platform of Game Company C link to the point exchange platform simultaneously, and each of the game platforms 16 has a plurality of different games.

The point exchange platform 14 links to the E-business platform 12 and the game platform 16. The rear end of the point exchange platform 14 is connected with a point exchange server 142. The point exchange server 142 stores game lists generated according to the games of the game platforms. While a member has entered into the point exchange platform 14, the point exchange server 142 can determine which one of the E-business platforms 12 the member comes from. While a member logs in the E-business platform 12 and selects a service of converting feedback points into game points, the webpage jumps to the point exchange platform 14. Then, the point exchange platform 14 presents a webpage having a game list, which lists the games of the linkable game platforms 16, whereby the member can select one of the listed games for point exchange. The game selected by the member is called the selected game. The point exchange platform 14 will jump to the game platform 16 through an application interface so as to present an input webpage of a game account to allow member to input the game account number of the selected game to the input webpage. Then, the game platform 16 jumps back to the point exchange platform 14. After the point exchange platform 14 receives the member data of the member, which is transmitted by the E-business platform 12, and the game selection information, the point exchange platform 14 learns the selected game, the game account number, the feedback points of the member, etc. Then, the point exchange platform 14 converts the feedback points of the member into game points, which may be used in the loyalty card of the selected game, and provides the game points to the selected game.

Users normally pay for online games with loyalty cards. The issuers of loyalty cards, such as the iWIN platform, the CASH platform and the MyCard platform, are equivalent to the point exchange platform 14 of the present invention. The issuers normally issue game loyalty cards to channels in fixed nominal amounts, such as 50 points, 150 points and 300 points. After purchasing a game loyalty card, the consumer himself must enter into the game to input the serial number and password so as to acquire the game points equivalent to the points of the loyalty card. The abovementioned process consumes time. Further, the user may input a wrong password. The present invention can directly exchange bonus points or feedback points into game points of a loyalty card. The present invention does not demand that the exchanged points must be of a given amount. Suppose that the quid pro quo relationship of the game points and the feedback points is 1:1. Thus, 16 feedback points can be totally converted into 16 game points. Therefore, the present invention can effectively digest trifle amounts of points.

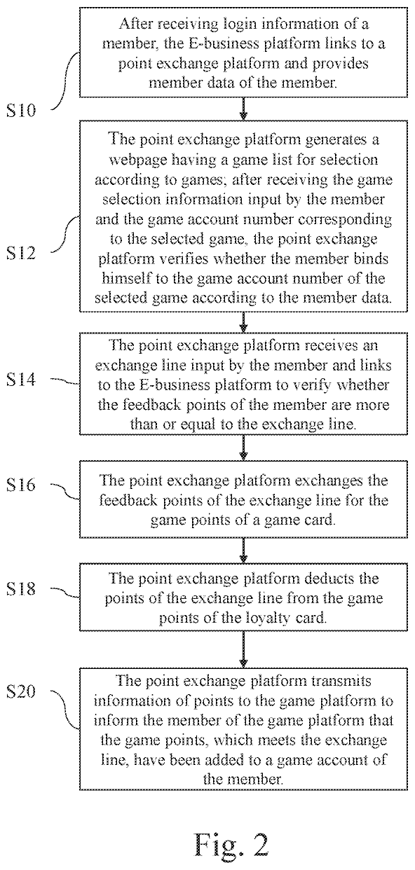

Refer to FIG. 2, which is a flowchart of a cross-platform point exchange method of the present invention. In Step S10, after the E-business platform 12 receives login information of a member, the E-business platform 12 links to the point exchange platform 14 and provides the member data of the member. In Step S12, the point exchange platform 14 generates a webpage having a game list for selection according to games; after the member selects a game from the game list (as the selected game), a piece of game selection information is generated; after the point exchange platform 14 receives the game selection information input by the member and the game account number corresponding to the selected game, the point exchange platform 14 verifies whether the member binds himself to the game account number of the selected game according to the member data. In Step S14, the point exchange platform 14 undertakes verification of points; the point exchange platform 14 receives an exchange instruction input by the member, wherein the exchange instruction includes the E-business platform 12 whose feedback points are to be exchanged, and an exchange line; the point exchange platform 14 links to the corresponding E-business platform 12 according to the exchange instruction through an application interface to verify whether the feedback points of the member are more than or equal to the exchange line; if the answer is Yes, it means that the feedback points is sufficient to exchange game points of the exchange line. In Step S16, the point exchange platform 14 exchanges the feedback points meeting the exchange line for the game points of a game card. In Step S18, the point exchange platform 14 deducts the points of the exchange line from the game points of the loyalty card. In Step S20, the point exchange platform 14 transmits the information of points to the game platform 16, whereby to inform the member of the game platform 16 that the game points, which meets the exchange line, have been added to the game account of the member.

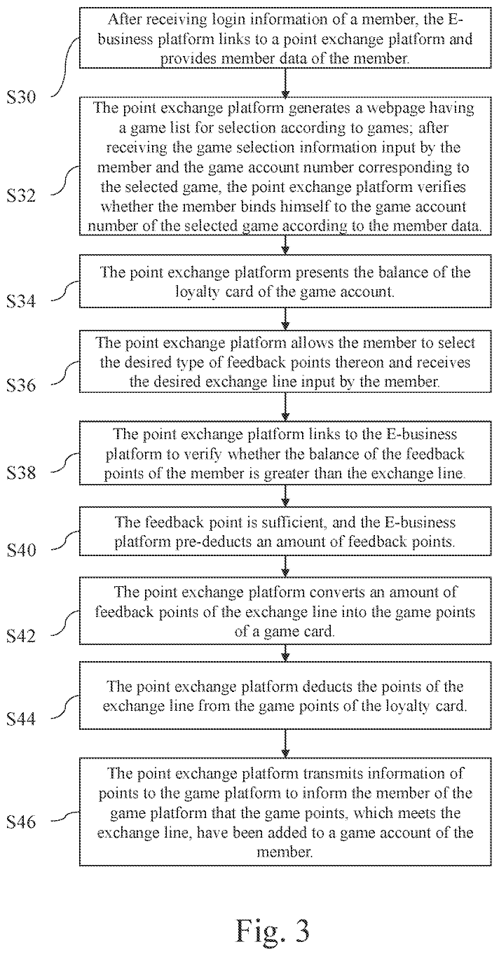

Refer to FIG. 3, which is a detailed flowchart of a cross-platform point exchange method of the present invention. Step S30 and Step S32 in FIG. 3 are respectively identical to Step S10 and Step S12 in FIG. 2. In Step S30, after the E-business platform 12 receives login information of a member, the E-business platform 12 links to the point exchange platform 14 and provides the member data of the member, which includes personal data of the member, such as the telephone number, the mobile phone number and the electronic mailbox that can be used to verify the identity of the member. In Step S32, the point exchange platform 14 generates a webpage having a game list for selection according to games; after the member selects a game from the game list (as the selected game), a piece of game selection information is generated; after the point exchange platform 14 receives the game selection information input by the member and the game account number corresponding to the selected game, the point exchange platform 14 verifies whether the member binds himself to the game account number of the selected game according to the member data. To describe in detail, after the member selects a game from the webpage having the game list as the selected game, the step of inputting the selected game into the game account is performed on the input webpage of the game platform 16, wherein the point exchange platform 14 jumps to the game platform 16; after the game account is input to the game platform 16, the webpage returns to the point exchange platform 14 with the balance of the loyalty card of the game account presented on the user interface of the point exchange platform 14; thus, the point exchange platform 14 receives the game account of the selected game (Step S34). In Step S36, the member selects the type of feedback points; the point exchange platform 14 may link to several different E-business platforms; therefore, the point exchange platform 14 allows the member to select the type of the feedback points, such as ET mall coins or MOMO coins; then, the point exchange platform 14 lets the member input the desired exchange line. In Step S38, the system performs the verification of points; the point exchange platform 14 links to the selected E-business platform 12, such as the ET mall platform, through the application interface to verify whether the balance of the feedback points of the member is greater than the exchange line; for example, if the member selects the ET mall coins, the point exchange platform 14 links to the ET mall platform to verify whether the amount of the ET mall coins is greater than the exchange line; if the answer is Yes, it means that the feedback points (i.e. the ET mall coins) of the member are sufficient to be converted into the game points of the exchange line. After the verification of points, the process proceeds to Step S40. In Step S40, the E-business platform 12 deducts an amount of feedback points, which is equal to the exchange line, from the balance of the feedback points. In Step S42, the point exchange platform 14 converts an amount of feedback points, which is equal to the exchange line, into the game points of a game card and then records the amount of exchange in the account of the member. Step S44 and Step S46 are respectively identical to Step S18 and Step S20 in FIG. 2. After the feedback points have been converted into the game point and the amount of exchange has been recorded in the account of the member, the point exchange platform 14 deducts the amount of the exchange line from the game points of the loyalty card and transmits a piece of information of points to the game platform 16 so as to inform the member that the game points meeting the exchange line have been added to the game account of the member. If the game platform 16 confirms the supplied points, the game platform 16 returns the status to the point exchange platform 14. After the deal is completed, the point exchange platform 14 informs the E-business platform 12 of the result of the deal. If the deal fails, the pre-deducted feedback points are returned to the member. If the deal succeeds, the bill is settled.

In Step S36, while the point exchange platform 14 provides the member with the types of points for selection, the point exchange platform 14 will perform a prejudgment, wherein the point exchange server 142 determines the channel through which the member enters the point exchange platform 14 and regards the channel and the default channel. For example, if the member is an ET mall member and enters the point exchange platform 14 from the ET mall platform, the point exchange platform 14 makes the ET mall coins as the default feedback points of the member. Because the point exchange platform 14 links to a plurality of E-business platforms 12, the point exchange platform 14 may provide a plurality of types of feedback points for selection and allow the member to make a single choice or multiple choices for the types of feedback points. For example, the ET mall coins and the MOMO coins are jointly exchanged. In Step S40, the point exchange platform 14 demands the ET mall platform and the MOMO shopping platform to make pre-deduction. In Step S46, while the bill is settled, the point exchange platform 14 informs the ET mall platform and the MOMO shopping platform of the bill settlement.

In Step S42, the point exchange platform 14 may provide exchange service for different loyalty cards. The point exchange platform 14 may link to loyalty cards available in the market for cooperation, such as iWIN, CASH, and MyCard, whereby the member may select a bonus point exchange service by himself Especially, the E-business platform 12 has a point settlement mechanism, which can calculate the quid pro quo relationships among the E-business platforms 12, the point exchange platform 14 and the game platforms 16. For example, 100 feedback points may be exchanged with 50 game points of Game Card A or 100 game points of Game Card B.

In conclusion, the present invention proposes a cross-platform point exchange system and a method thereof, which uses an application interface to link E-business platforms, a point exchange platform and game platforms. The point exchange platform may automatically jump to a game platform to verify the balance of the game points and may automatically jump to an E-business platform to verify the balance of the feedback points. After deduction of points, the point exchange platform automatically informs the game platform of deduction and instantly enters the points into the game account of the member through the application interface. While applied to mobile phones, the present invention can save the time that the conventional technology spent in manually inputting the serial number and password of the loyalty card and decrease the error rate of inputting the password. The present invention also provides a mechanism to convert the feedback point given by E-business platform into game points, whereby to accelerate the digestion of bonus points and decrease the cost of the performance guarantee, which the E-business platform spends for the feedback points. Further, the present invention supports flexible exchange lines. The user needn't accumulate the feedback points to a specified amount. In the present invention, even a minor amount of feedback points can also be exchanged into game points. Therefore, the present invention can expand the application field of minor amounts of feedback points and accelerate the digestion of feedback points.

The embodiments described above are only to exemplify the present invention but not to limit the scope of the present invention. Any equivalent modification or variation according to the spirit or characteristics of the present invention is to be also included by the scope of the present invention.

What is claimed is:

1. A cross-platform point exchange system, comprising
an E-business platform, storing a plurality of feedback points and at least one piece of member data of at least one member, wherein the at least one member data has the feedback points;
a game platform, providing a plurality of games; and
a point exchange platform, in signal connection with the E-business platform and the game platform, receiving the at least one piece of member data, generating a webpage having a game list according to the games, and receiving game selection information input by the at least one member, wherein the point exchange platform converts the feedback points in the member data into game points of a loyalty card and provides the game points to a selected game corresponding to the game selection information.

2. The cross-platform point exchange system according to claim 1, wherein the member data includes a telephone number of the member, a mobile phone number of the member, an electronic mailbox of the member, or an account number registered in the E-business platform of the member to enable the point exchange platform to verify whether the member binds himself to a game account number of the selected game in the game platform.

3. The cross-platform point exchange system according to claim 2, wherein after the point exchange platform receives the game selection information, the point exchange platform jumps to the game platform to present an input webpage of the game account number.

4. The cross-platform point exchange system according to claim 3, wherein after the input webpage receives a piece of input of the game account number, the game account number and a balance of a loyalty card of the game account number jointly jump back to the point exchange platform, and the balance of the loyalty card of the game account number is presented on the point exchange platform.

5. The cross-platform point exchange system according to claim 1, wherein the point exchange platform receives an exchange instruction input by the member; the exchange instruction includes an E-business platform, which is selected to exchange the feedback points, and an exchange line; according to the exchange instruction, the point exchange platform links to the E-business platform, which is selected to exchange the feedback points, to verify whether the feedback points are more than or equal to the exchange line.

6. The cross-platform point exchange system according to claim 1, wherein the loyalty cards include a plurality of game point cards provided by a plurality of point issuers; the point exchange platform provides the plurality of game point cards for the member to select at least one of the plurality of game point cards for exchange of the feedback points; the point exchange platform calculates the quid pro quo relationship to determine an exchange rate.

7. The cross-platform point exchange system according to claim 5, wherein the loyalty cards include a plurality of game point cards provided by a plurality of point issuers; the point exchange platform provides the plurality of game point cards for the member to select at least one of the plurality of game point cards for exchange of the feedback points; the point exchange platform calculates the quid pro quo relationship to determine an exchange rate.

8. The cross-platform point exchange system according to claim 5, wherein while the feedback points are more than or equal to the exchange line, the E-business platform pre-deducts the exchange line from the feedback points of the member; after the feedback points of the exchange line have been converted into game points of the loyalty card, the E-business platform confirms that the feedback points of the member have been deducted successfully.

9. The cross-platform point exchange system according to claim 8, wherein after the feedback points of the exchange line have been converted into the game points of the loyalty card, the point exchange platform deducts the points of the exchange line from the game points of the loyalty card and transmits information of points to the game platform to inform the member of the game platform that the game points, which meets the exchange line, have been added to one game account of the member.

10. The cross-platform point exchange system according to claim 1, wherein a game server is connected to a rear end of the game platform for storing and executing the plurality of games and also storing a plurality of game accounts and related information.

11. The cross-platform point exchange system according to claim 1, wherein an E-business server is connected to a rear end of the E-business platform for storing data, consumption records, and balances of the feedback points of the members in the E-business platform.

12. The cross-platform point exchange system according to claim 11, wherein a point exchange server is connected with a rear end of the point exchange platform; the E-business server and the point exchange server respectively belong to different companies.

13. A cross-platform point exchange method, which converts a plurality of feedback points of an E-business platform into game points required by a game platform through a point exchange platform, and which comprises steps:
after the E-business platform receives login information of a member, the E-business platform links to a point exchange platform and provides member data to the point exchange platform, wherein the member data includes a plurality of feedback points;
the game platform includes a plurality of games; the point exchange platform generates a webpage having a game list for selection according to the plurality of games; the member selects a game from the game list as a selected game; after the point exchange platform receives a piece of game selection information input by the member and a game account number corresponding to the selected game, the point exchange platform verifies whether the member binds himself to the game account number of the selected game according to the member data;
the point exchange platform receives an exchange line input by the member and links to the E-business platform to verify whether the feedback points of the member are more than or equal to the exchange line; and
after the point exchange platform exchanges the feedback points of the exchange line for the game points of a game card, the point exchange platform deducts the exchange line from the game points of a loyalty card and transmits information of points to the game platform so as to inform the member of the game platform that the game points, which meets the exchange line, have been added to the game account number of the member.

14. The cross-platform point exchange method according to claim 13, wherein the member data includes a telephone number of the member, a mobile phone number of the member, an electronic mailbox of the member, or an account number registered in the E-business platform of the member to enable the point exchange platform to verify whether the member binds himself to the game account number of the selected game in the game platform.

15. The cross-platform point exchange method according to claim 13, wherein after the point exchange platform receives the game selection information, the point exchange platform jumps to the game platform to present an input webpage of the game account number.

16. The cross-platform point exchange method according to claim 15, wherein after the input webpage receives a piece of input of the game account number, the game account number and a balance of a loyalty card of the game account number jointly jump back to the point exchange platform, and the balance of the loyalty card of the game account number is presented on the point exchange platform.

17. The cross-platform point exchange method according to claim 13, wherein an exchange instruction, which is input by the member, includes an exchange line; the exchange instruction further includes one E-business platform, which is selected to exchange the feedback points; according to the exchange instruction, the point exchange platform links to the E-business platform, which is selected to exchange the feedback points, to verify whether the feedback points are more than or equal to the exchange line.

18. The cross-platform point exchange method according to claim 13, wherein the loyalty cards include a plurality of game point cards provided by a plurality of point issuers; the point exchange platform provides the plurality of game point cards for the member to select at least one of the plurality of game point cards for exchange of the feedback points; the point exchange platform calculates the quid pro quo relationship to determine an exchange rate.

19. The cross-platform point exchange method according to claim 17, wherein the loyalty cards include a plurality of game point cards provided by a plurality of point issuers; the point exchange platform provides the plurality of game point cards for the member to select at least one of the plurality of game point cards for exchange of the feedback points; the point exchange platform calculates the quid pro quo relationship to determine an exchange rate.

20. The cross-platform point exchange method according to claim 17, wherein while the feedback points are more than or equal to the exchange line, the E-business platform pre-deducts the exchange line from the feedback points of the member; after the feedback points of the exchange line have been converted into game points of the loyalty card, the E-business platform confirms that the feedback points of the member have been deducted successfully.
